(19) United States
(12) Patent Application Publication
(10) Pub. No.: US 2022/0131719 A1
(43) Pub. Date: Apr. 28, 2022

(54) FORWARDING DOMAIN ALLOCATION METHOD AND APPARATUS, STORAGE MEDIUM, AND ELECTRONIC DEVICE

(71) Applicant: Suzhou Centec Communications Co., Ltd., Suzhou, Jiangsu (CN)

(72) Inventors: Haiqing XU, Suzhou, Jiangsu (CN); Run HONG, Suzhou, Jiangsu (CN); Jie ZHOU, Suzhou, Jiangsu (CN); Guoliang ZHAO, Suzhou, Jiangsu (CN); Wengang WANG, Suzhou, Jiangsu (CN)

(21) Appl. No.: 17/295,885

(22) PCT Filed: Nov. 18, 2019
(86) PCT No.: PCT/CN2019/119194

§ 371 Date: May 21, 2021

(30) Foreign Application Priority Data
Nov. 27, 2018 (CN) 201811438119.1

(51) Int. Cl. H04L 12/46; H04L 45/00

(52) U.S. Cl. CPC H04L 12/46; H04L 45/66

(57) ABSTRACT

Provided are a forwarding domain allocation method and device, a storage medium, and an electronic device. The method may includes: acquiring target messages from different input ports, the number of the acquired target messages being greater than or equal to the number of input ports; acquiring identifier information carried in the target message; and on the basis of the identifier information carried in the target message, allocating a forwarding domain to the target message.

### CROSS-REFERENCE TO RELATED APPLICATIONS

The present disclosure claims priority to Chinese Patent Application No. 201811438119.1, filed to the China Patent Office on Nov. 27, 2018, the disclosure of which is hereby incorporated by reference in its entirety.

### TECHNICAL FIELD

The present disclosure relates to the field of communications, and more particularly to a forwarding domain allocation method and device, a storage medium, and an electronic device.

### BACKGROUND

The same messages (svlan+macda are the same) input from different ports can be output from the different ports, which is called a VLAN (Virtual Local Area Network) slicing. In a network in the prior art, VOLT (Virtual Optical Line Terminal) support virtualization is realized by slicing VLAN. Specifically, a FID (Forwarding Instance ID) of a chip is divided into a plurality of copies. Each port corresponding to the FID is divided into different VOLTs, and the corresponding fid base (an initial forwarding domain value) is output on the port. According to the svlan+the fid base (an outer layer of VLANs and the initial forwarding domain value) carried in the input message, the VLAN (Virtual Local Area Network) slicing and the VOLT support virtualization are realized.

In the conventional art, the implementation of the VOLT support virtualization has the following defects: (1) The number of the VOLTs supported is limited. Each VOLT needs to divide and reserve 4K FIDs. Generally, practical application does not need to support all 4K VLANs, which causes resource wastage; (2) the VLAN slicing is not flexible enough. All VLANs are sliced in the VOLT, and it is not supported that part of the VLANs are not sliced in the VOLT. In the prior art, in a process of implementing the VOLT support virtualization, all VLANs need to be sliced. It is not supported that part of the VLANs are not sliced in the VOLT, which causes a problem of resource wastage. Currently, no effective solution has been proposed yet.

### SUMMARY

The embodiments of the present disclosure provide a forwarding domain allocation method and device, a storage medium, and an electronic device, so as to at least solve the problem in the prior art of resource wastage caused by needing to slice all VLANs and the unsupported partial VLAN in VOLT not being sliced when implementing a VOLT support virtualization process.

According to an embodiment of the present disclosure, a forwarding domain allocation method is provided, and the method includes the following steps: acquiring target messages from different input ports, the number of the acquired target messages being greater than or equal to the number of input ports; acquiring identifier information carried in the target messages; and allocating forwarding domains to the target messages on the basis of the identifier information carried in the target messages.

In an embodiment, allocating the forwarding domains to the target messages according to the identifier information carried in the target messages comprises the following step: determining the forwarding modes of the target messages according to the identifier information carried in the target messages. The forwarding modes include a first forwarding mode for indicating the target messages to be forwarded by the same forwarding domain and a second forwarding mode for indicating the target messages to be forwarded by different forwarding domains.

In an embodiment, after determining the forwarding modes of the target messages according to the identifier information, the method further includes the following steps: if the forwarding modes of the target messages are the first forwarding mode, allocating the same forwarding identifier to the target messages; and indicating the target messages to be forwarded from the forwarding domain corresponding to the forwarding identifier.

In an embodiment, after determining the forwarding modes of the target messages according to the identifier information, the method further includes the following steps: if the forwarding modes of the target messages are the second forwarding mode, determining whether the target messages come from the same terminal; if the target messages come from the same terminal, allocating the target messages to the same forwarding identifier; if the target messages come from different terminals, allocating the same forwarding identifier to the target messages from the same terminal, allocating different forwarding identifiers to the target messages from the different terminals; and indicating the target messages to be forwarded from the forwarding domain corresponding to the forwarding identifier.

In an embodiment, determining whether the target messages come from the same terminal includes the following steps: parsing out the input port numbers in the identifier information carried in all target messages; determining that the target messages with the same input port number in the identifier information come from the same terminal; and determining that the target messages with different input port numbers in the identifier information come from the different terminals.

In an embodiment, before acquiring the target messages from the different input ports, the method further includes the following step: allocating the input port numbers to the input ports, where the input port numbers allocated to different ports from the same terminal are the same, and the input port numbers allocated to the different ports from the different terminals are different.

According to an embodiment of the present disclosure, a forwarding domain allocation device is provided, and the device includes: a first acquiring module, configured to acquire target messages from the different input ports, the number of the acquired target messages being greater than or equal to the number of input ports; a second acquiring module, configured to acquire identifier information carried in the target messages; and an allocating module, configured to allocate forwarding domain to the target messages according to the identifier information carried in the target messages.

In an embodiment, the allocating module is further configured to determine the forwarding modes of the target messages according to the identifier information carried in the target messages. The forwarding modes include a first forwarding mode for indicating the target messages to be forwarded by the same forwarding domain and a second forwarding mode for indicating the target messages to be forwarded by different forwarding domains.

According to another embodiment of the present disclosure, further provided is a storage medium. A computer program is stored in the storage medium, and the computer program is configured to execute steps in the methods of the forgoing embodiments when the computer program is operated.

According to another embodiment of the present disclosure, further provided is an electronic device, which includes a memory and a processor. A computer program is stored in the memory. The processor is configured to execute the computer program to execute the steps in the method of the forgoing embodiments.

According to the present disclosure, as the forwarding domain are allocated to the target messages on the basis of identifier information carried in the target messages acquired from the different input ports, the present disclosure solves the problem in the prior art of resource wastage caused by needing to slice al VLANs and the unsupported partial VLAN in the VOLT not being sliced when implementing a VOLT support virtualization process, and implements flexible slicing of VLAN on the basis of actual conditions, achieving the effect of saving resources.

### BRIEF DESCRIPTION OF THE DIAGRAMS

The drawings described here are used to provide a further understanding of the present disclosure and constitute a part of this application. The exemplary embodiments of the present disclosure and the description thereof are used to explain the present disclosure, and do not constitute an improper limitation thereto. In the drawings:

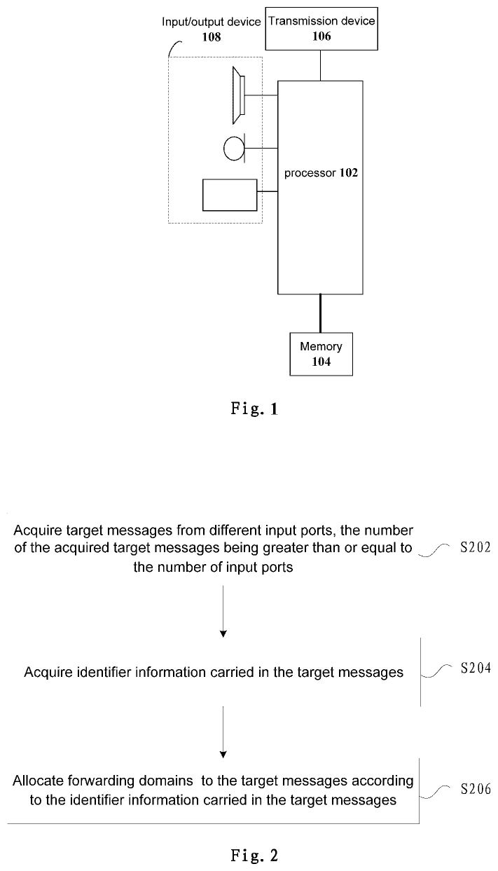

FIG. 1 is a block diagram of a hardware structure of a computer terminal that allocates a forwarding domain according to an embodiment of the present disclosure;

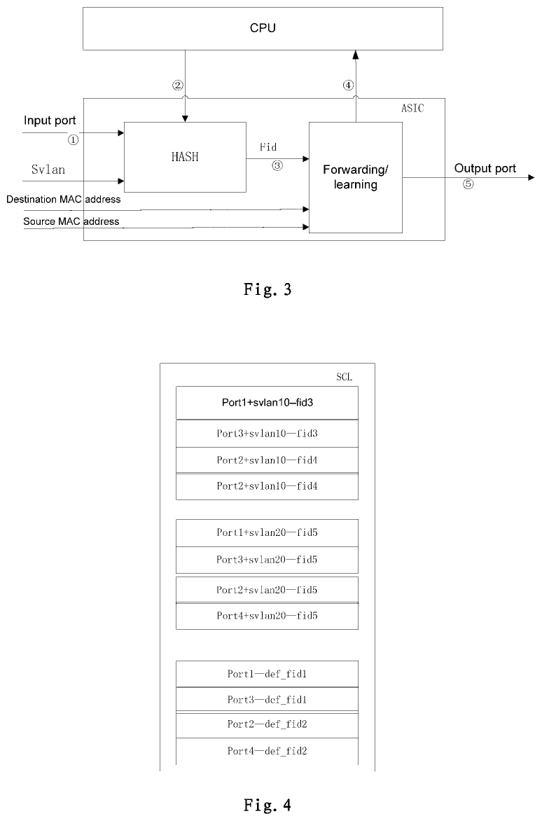

FIG. 2 is a flowchart of a forwarding domain allocation method according to an embodiment of the present disclosure;

FIG. 3 is a flowchart of VLAN slicing processed by a chip according to an embodiment of the present disclosure;

FIG. 4 is a schematic diagram of an entry of an SCL terminal according to an embodiment of the present disclosure;

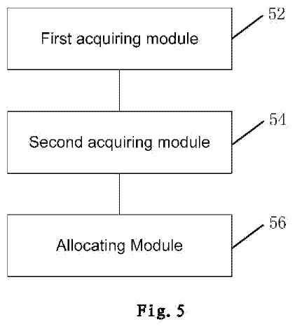

FIG. 5 is a structural block diagram of a forwarding domain allocation device according to an embodiment of the present disclosure.

### DETAILED DESCRIPTION OF THE EMBODIMENTS

Hereinafter, the present disclosure is described in detail with reference to the drawings and in conjunction with embodiments. It should be noted that the embodiments in this application and the features in the embodiments may be combined with each other if there is no conflict.

It should be noted that the terms “first” and “second” in the description and claims of the present disclosure and the forgoing drawings are used to distinguish similar objects, but are not necessarily used to describe a specific order or sequence.

A method embodiment provided in Embodiment 1 of this application may be executed in a mobile terminal, a computer terminal, or a similar computing device. Taking as an example that the method is executed on the computer terminal, FIG. 1 is a block diagram of a hardware structure of a computer terminal that allocates a forwarding domain according to an embodiment of the present disclosure. As shown in FIG. 1, the computer terminal 10 may comprise one or a plurality of (only one is shown in FIG. 1) processors 102 (the processor 102 may comprise, but is not limited to, a processing device such as a microprocessor MCU or a programmable logic device FPGA) and a memory 104 configured to store data. In an embodiment, the forgoing computer terminal may also comprise a transmission device 106 and an input/output device 108 arranged as having communication functions. The person skilled in the art may understand that a structure shown in FIG. 1 is only for illustration, and does not limit a structure of the foregoing computer terminal. For example, the computer terminal 10 may further comprise more or less assemblies than that shown in FIG. 1, or have a different configuration from that shown in FIG. 1.

The memory 104 may be configured to store computer program, such as software program and a module of application software, such as computer program corresponding to the forwarding domain allocation method in the embodiment of the present disclosure. The processor 102 executes the computer program stored in the memory 104 to execute various functional applications and data processing, that is, to realize the forgoing method. The memory 104 may comprise a high-speed random access memory, and may also comprise a non-volatile memory, such as one or a plurality of magnetic storage devices, flash memories, or other non-volatile solid-state memories. In some examples, the memory 104 may further comprise a memory remotely arranged relative to the processor 102, and these remote memories may be connected to the mobile terminal 10 via a network. Examples of the foregoing networks comprise, but are not limited to, the Internet, an intranet, a local area network, a mobile communication network and their combinations.

A transmission device 106 is configured to receive or transmit data via one network. The specific example of the forgoing network may comprise a wireless network provided by a communication provider of the computer terminal 10. In one example, the transmission device 106 comprises a Network Interface Controller (NIC), which may be connected to other network devices via a base station so as to communicate with the Internet. In one example, the transmission device 106 may be a Radio Frequency (RF) module, which is configured to communicate with the Internet in a wireless manner.

In this embodiment, a forwarding domain allocation method is provided, and the method can be executed on the above computer terminal. FIG. 2 is a flowchart of the forwarding domain allocation method according to an embodiment of the present disclosure. As shown in FIG. 2, the method may include the following steps:

Step S202: acquiring target messages from different input ports, the number of the acquired target messages being greater than or equal to the number of input ports.

One input port inputs at least one target message. SVLAN and MACDA (Media Access Control Destination Address) of the acquired target message are the same.

Step S204: acquiring identifier information carried in the target messages.

The identifier information carried in the target messages include the input port number, SVLAN, MACDA, and MACSA (Media Access Control Source Address). The identifier information may be carried in a certain field of the target message. For example, a first field of the message is the input port number; a second field of the message is the SVLAN; a third field of the message is the MACDA, and a fourth field of the message is the MACSA.

Step S206: allocating a forwarding domain to the target message according to the identifier information carried in the target message.

On the basis of the identifier information carried in the target message, the forwarding domain is allocated to the target message

In the conventional art, not all terminals should support virtualization, that is, not all received message comes from the message needing to perform VLAN slicing. However, in the prior art, implementing the terminal to support the virtualization requires to perform VLAN slicing on all messages. With the forgoing steps of this application, the forwarding domain is allocated to the target message on the basis of the identifier information carried in the target message acquired from the different input ports; that is to say, the forgoing steps in this application may determine whether the target message needs to perform VLAN slicing via the identifier information carried in the target message, and then allocate the corresponding forwarding domain to the target message. Therefore, the present disclosure solves the problem in the prior art of resource wastage caused by needing to slice all VLANs and the unsupported partial VLAN in VOLT not being sliced when implementing a VOLT support virtualization process, and implements flexible slicing of VLAN on the basis of actual conditions, achieving the effect of saving resources.

In an embodiment, the execution body of the foregoing steps may be a terminal or the like, but is not limited thereto.

In an embodiment, the step of allocating the forwarding domain to the target message according to the identifier information carried in the target message may include the following step: determining a forwarding mode of the target message according to the identifier information carried in the target message. The forwarding mode comprises a first forwarding mode for indicating the target message to be forwarded by the same forwarding domain and a second forwarding mode for indicating the target message to be forwarded by different forwarding domains. In this embodiment, whether the target message requires VLAN slicing may be determined by CPU, where the target message needing the VLAN slicing means that the same message (corresponding to the target message) acquired from the plurality of different input ports is output from the different output ports. No need for the VLAN slicing means that the same message acquired from the plurality of different input ports is output from the same output port. The target message enters a SCL processing logic of a chip, and determines whether the target message needs to perform the VLAN slicing according to the input port and the SVLAN of the target message in the identifier information. An SCL entry may be managed by the CPU (certain entries are added or deleted). If the target message does not require the VLAN slicing, the forwarding mode corresponding to the target message is the first forwarding mode, and a plurality of the same target messages is forwarded from the same forwarding domain. If the target message requires the VLAN slicing, the forwarding mode corresponding to the target message is the second forwarding mode, and a plurality of the same target messages is forwarded from the different forwarding domains.

In an embodiment, after determining the forwarding mode of the target message according to the identifier information, the method may further include the following steps: if the forwarding mode of the target message is the first forwarding mode, allocating the same forwarding identifier to the target message; and indicating the target message to be forwarded from the forwarding domain corresponding to the forwarding identifier. In this embodiment, if the identifier information carried in the plurality of the same acquired target messages indicates that the target message does not require the VLAN slicing, the target message needs to be forwarded from the same forwarding domain (corresponding to the first forwarding mode). At this time, the same forwarding identifier is allocated to the plurality of the same target messages, and the plurality of the same target messages is all forwarded from the forwarding domain corresponding to the forwarding identifier.

In an embodiment, after determining the forwarding mode of the target message according to the identifier information, the method may further include the following steps: if the forwarding mode of the target message is the second forwarding mode, determining whether the target message comes from the same terminal; if the target message comes from the same terminal, allocating the target message to the same forwarding identifier; if the target message comes from different terminals, allocating the same forwarding identifier to the target message from the same terminal, allocating different forwarding identifiers to the target message from the different terminals; and indicating the target message to be forwarded from the forwarding domain corresponding to the forwarding identifier. In this embodiment, if the identifier information carried in the plurality of the same acquired target messages indicates that the target message requires the VLAN slicing (corresponding to the second forwarding mode), it is further determined whether the acquired target message comes from the same terminal. The same forwarding identifier is allocated to the target message from the same terminal. The forwarding identifier may be a default forwarding identifier allocated to the terminal by the CPU. The different forwarding identifiers are allocated to the target message from the different terminals. The target message is forwarded from the forwarding domain corresponding to the forwarding identifier.

In an embodiment, the step of determining whether the target messages come from the same terminal can be realized by the following implementations: parsing out an input port number in the identifier information carried in all target messages; determining that the target messages with the same input port number in the identifier information come from the same terminal; and determining that the target messages with different input port numbers in the identifier information come from the different terminals. In this embodiment, the identifier information carried in the target message comprises the port number input by the target message, and the port numbers of the different ports in the same terminal are the same. Whether the target message is input from the same terminal is determined by determining whether the input port numbers in the identifier information carried by the target message are the same.

In an embodiment, before acquiring the target message from the plurality of different input ports, the method may further comprises the following step: allocating the input port number to the input port, where the input port numbers allocated to the different ports from the same terminal are the same, and the input port numbers allocated to different ports from the different terminals are different. In this embodiment, the same input port number is allocated to the different ports from the same terminal. Different input port numbers are allocated to the ports from the different terminals. Whether the input ports are from the same terminal is determined by determining whether the port numbers are the same. When the target message is input from the input port, the identifier information of the target message carries the input port number corresponding to the input port; that is, the input port number in the identifier information carried in the target message and the port number of the terminal are the same.

The following specific embodiments are used to describe this disclosure.

For the embodiment of the present disclosure, the VLAN slicing is flexibly supported in the chip according to an input port of the message and SVLAN carried in the message, thereby achieving the objective of supporting virtualization of the plurality of VOLTs. The plurality of VOLTs may be flexibly supported. VLAN services may be supported according to actual application needs, and FID is flexibly allocated, thereby reducing the resource wastage and saving a system vendor' costs. On the other hand, support for flexible VLAN slicing is added and the user' support for part of the VLANs not being sliced is met.

In the VOLT, two layers of basic forwarding services are generally provided. Whether a transparent transmission service, an ONU (Optical Network Unit, here, it refers to a message coming from a specific ONU device) service, or a PON (Passive Optical Network, here, it refers to a message coming from a specific PON port) service has the same processing processes of forwarding in essence. That is, it is usually necessary to search for the corresponding output port according to the MACDA and the FID of the message. To support the VOLT, it is necessary to ensure that the same message (svlan+macda are the same) that enters from the different ports may be output from the different ports. This requires the chip to be able to map to different output ports (the VLAN is sliced) according to the svlan and the input ports. In addition, the plurality of messages is supported (svlan+macda is the same). Even if the message enters from the different ports, the message may still be output from the same port (the VLAN is not sliced).

The following describes the VLAN slicing processed by the chip according to the flowchart of the chip in FIG. 3. As shown in FIG. 3, the flowchart of the VLAN slicing processed by the chip according to an embodiment of the present disclosure mainly comprises:

1) A chip ASIC parses the message, and acquires an In Port (corresponding to the input port number) of the message, the SVLAN (an outer layer of the VLANs) carried in the message, and the MACDA and the MACSA of the message (the input port, the SVLAN, the MACDA and MACSA correspond to the identifier information carried in the target message). According to the In Port+the Svlan, the HASH (hash/hash) entry of the chip is searched for to acquire the FID (Forwarding Instance ID).

2) The message enters the SCL processing logic of the chip, and the FID is output according to the port and the SVLAN. The SCL entry is managed, added and deleted by the CPU (Central Processing Unit). In addition, the CPU determines whether the VLAN is sliced.

If the VLAN is sliced, the different ports that carry a message of the VLAN are input, and different FIDs (corresponding to the forwarding identifiers) are output. If a message carrying VLAN10 enters from Port1 and port2 belonging to the VOLT respectively, two related entries Port 1+vlan 10->fid 1 and Port2+vlan10->fid2 are provided in the SCL. FID1 (corresponding to the forwarding identifier) and FID2 (corresponding to the forwarding identifier) are in the different forwarding domains.

If the VLAN is not sliced, the different ports that carry the message of the VLAN are input, and the same FIDs (corresponding to the forwarding identifiers) are output. If a message carrying VLAN20 enters from the Port1 and the port2 belonging to VOLT, two related entries are provided in the SCL. The FIDs are the same: Port1+vlan10->fid and Port2+vlan10->fid, that is, these two belong to the same forwarding domain.

If the message enters from this port once, the message matches a default entry of the VOLT and output a default FID (corresponding to the forwarding identifier). The default FID is allocated to the VOLT by the CPU when the VOLT is initialized. In addition, all ports belonging to the VOLT are added to the forwarding domain of the default FID.

3) The message enters the chip's forwarding and learning (corresponding to the Forwarding/Learing in FIG. 3) processing logics. First, a forwarding entry is searched for according to a forwarding logic and forwarded to a corresponding output port. In addition, MAC learning of the message is carried out.

4) If the message enters for the first time, the chip reports the MACSA, the SVLAN and the input port of the message to the CPU. The CPU determines whether the FID of the message is the default FID of the VOLT, and if the FID is the default FID of the message, one FID is allocated according to the input port and the SVLAN. In addition, the entry is delivered to a SCL unit of the chip.

5) The message is further input into other logic units of the chip for processing, and is output from the searched output port.

The following examples are used for description.

For example, a current system is as follows: two VOLTs which are VOLT1 and VOLT2 respectively are provided. The default FIDs (corresponding to the forwarding identifiers) of VOLT1 and VOLT2 are 1 and 2, respectively. In addition, the Port1 and port3 belong to the VOLT1, and the port 2 and port 4 belong to the VOLT2. VLAN10 of the target message is sliced, but the VLAN20 is not sliced. The entry in the SCL is shown in FIG. 4.

Since the Port1 and the port3 both belong to the VOLT1, the default FIDs of the Port1 and the port3 should be the same, and both are def_fidlo. Similarly, the default FIDs of the port2 and the port4 are both def_fid2.

If the VLAN20 is not sliced, no matter which port of the VOLT from which the VLAN20 enters, output FIDs should be the same. Therefore, four target message input from PORT1 to PORT4 in the SCL are all entries of FIDS (corresponding to the forwarding identifier).

If the VLAN 10 is sliced, the messages belonging to one VOLT should output the same FID. Therefore, the forwarding identifier of the VLAN 10 of the target message output by the Port1 and the port3 is fid3, and the forwarding identifier of the VLAN10 of the target message output by the port2 and the port4 is fid4.

Through the description of the forgoing embodiments, the person skilled in the art may clearly understand that the method according to the forgoing embodiments may be implemented by means of software and a necessary general hardware platform, and of course may also be implemented by hardware. However, in many cases, the former is better implementation. According to this understanding, the technical solution of the present disclosure could be essentially embodied in the form of a software product for a part that contributes to the prior art. The software product of the computer is stored in one storage medium (such as ROM/RAM, a diskette, and an optical disk) and includes a plurality of instructions which make one terminal device (which could be a mobile phone, a server, a network device or the like) execute the method described in various embodiments of the present disclosure.

In this embodiment, provided is a forwarding domain allocation device. The device is configured to implement the forgoing embodiments and preferred implementations, and those that have been described are not repeated here. As used below, the term “module” may implement a combination of software and/or hardware with predetermined functions. Although the device described in the following embodiments is preferably implemented by software, implementation by hardware or a combination of software and hardware is also possible and conceived.

FIG. 5 is a structural block diagram of the forwarding domain allocation device according to the embodiment of the present disclosure. As shown in FIG. 5, the device includes: a first acquiring module 52, configured to acquire target messages from different input ports, the number of the acquired target messages being greater than or equal to the number of input ports; a second acquiring module 54, configured to acquire identifier information carried in the target messages; and an allocating module 56, configured to allocate forwarding domains to the target messages on the basis of the identifier information carried in the target messages.

In an embodiment, the allocating module 56 is further configured to determine forwarding modes of the target messages according to the identifier information carried in the target messages. The forwarding modes may include a first forwarding mode for indicating the target messages to be forwarded by the same forwarding domain and a second forwarding mode for indicating the target messages to be forwarded by different forwarding domains.

In an embodiment, the forgoing device is further configured to: after determining the forwarding modes of the target message according to the identifier information, if the forwarding modes of the target messages are the first forwarding mode, allocate the same forwarding identifier to the target messages; and indicate the target messages to be forwarded from the forwarding domain corresponding to the forwarding identifier.

In an embodiment, the forgoing device is further configured to: after determining the forwarding modes of the target messages according to the identifier information, if the forwarding modes of the target messages are the second forwarding mode, determine whether the target messages comes from the same terminal; if the target messages come from the same terminal, allocate the target messages to the same forwarding identifier; if the target messages come from different terminals, allocate the same forwarding identifier to the target messages from the same terminal, allocate different forwarding identifiers to the target messages from the different terminals; and indicate the target messages to be forwarded from the forwarding domain corresponding to the forwarding identifier.

In an embodiment, the forgoing device is further configured to: parse out the input port numbers in the identifier information carried in al target messages; determine that the target messages with the same input port number in the identifier information come from the same terminal; and determine that the target message with different input port numbers in the identifier information come from the different terminals.

In an embodiment, the forgoing device is further configured to: before acquiring the target messages from the different input ports, allocate the input port numbers to the input ports, where the same input port numbers are allocated to the different ports from the same terminal, and the different input port numbers are allocated to different input ports from the different terminals.

It should be noted that each of the forgoing modules may be implemented by software or hardware. The hardware may be implemented in the following manner, but not limited thereto: the forgoing modules are all positioned in the same processor; or, the forgoing modules are positioned in different processors in any combination form.

According to an embodiment of the present disclosure, there is further provided a storage medium. A computer program is stored in the storage medium, where the computer program is configured to execute the steps in any one of the embodiments of the foregoing method when the computer program is operated.

In an embodiment, in this embodiment, the forgoing storage medium may be configured to store a computer program for executing the following steps:

S1: acquiring target messages from different input ports, the number of acquired target messages being greater than or equal to the number of input ports;

S2: acquiring identifier information carried in the target messages; and

S3: allocating forwarding domains to the target messages according to the identifier information carried in the target messages.

In an embodiment, in this embodiment, the forgoing storage medium may include, but is not limited to: U disk, a Read-Only Memory (ROM), a Random Access Memory(RAM), and various media such as a mobile hard disk, a magnetic disk, or an optical disk that can store a computer program.

According to an embodiment of the present disclosure, there is further provided an electronic device, comprising a memory and a processor. A computer program is stored in the memory. The processor is configured to execute the computer program to execute steps in any one of embodiments of a forgoing method.

In an embodiment, the forgoing electronic device may further comprise a transmission device and an input forwarding device, where the transmission device is connected to the forgoing processor, and the input forwarding device is connected to the forgoing processor.

In an embodiment, in this embodiment, the foregoing processor may be configured to execute the following steps through the computer program:

S1: acquiring target messages from different input ports, the number of the acquired target messages being greater than or equal to the number of input ports;

S2: acquiring identifier information carried in the target messages; and

S3: allocating forwarding domains to the target messages according to the identifier information carried in the target messages.

In an embodiment, for specific examples in this embodiment, reference may be made to the examples described in the forgoing embodiments and optional implementations, and details are not described herein again in this embodiment.

Obviously, the person skilled in the art should understand that the forgoing modules or steps of the present disclosure may be implemented by a general computing device, and may be concentrated on a single computing device or allocated in a network consisting of the plurality of the computing devices. In an embodiment, the forgoing modules or steps of the present disclosure may be implemented with program codes executable by the computing device. Therefore, the forgoing modules or steps of the present disclosure may be stored in a storage device for execution by the computing device. In some cases, the steps shown or described may be executed in a different order than an order herein, or the steps are fabricated into individual integrated circuit modules respectively, or the plurality of modules or steps of the forgoing modules or steps is fabricated into a single integrated circuit module for implementation. In this way, the present disclosure is not limited to any specific combination of hardware and software.

The forgoing descriptions are only preferred embodiments of the present disclosure, and are not used to limit the present disclosure. For the person skilled in the art, the present disclosure can have various modifications and changes. Any modification, equivalent replacement and improvement made within the principle of the present disclosure shall be included within the protection scope of the present disclosure.

### INDUSTRIAL APPLICABILITY

In a process of allocating a forwarding domain in this application, the forwarding domain is allocated to a target message on the basis of identifier information carried in the target message acquired from different input ports. the present disclosure solves the problem in the prior art of resource wastage caused by needing to slice all VLANs and the unsupported partial VLAN in the VOLT not being sliced when implementing a VOLT support virtualization process, and implements flexible slicing of VLAN on the basis of actual conditions, achieving the effect of saving resources.

1. A forwarding domain allocation method, comprising:
acquiring target messages from different input ports, and a number of the acquired target messages being greater than or equal to a number of input ports;
acquiring identifier information carried in the target messages; and
allocating forwarding domains to the target messages according to the identifier information carried in the target messages.

2. The method according to claim 1, wherein allocating the forwarding domains to the target messages according to the identifier information carried in the target messages comprises:
determining forwarding modes of the target messages according to the identifier information carried in the target messages;
the forwarding modes comprise a first forwarding mode for indicating the target messages to be forwarded by a same forwarding domain, and a second forwarding mode for indicating the target messages to be forwarded by different forwarding domains.

3. The method according to claim 5, wherein after determining the forwarding modes of the target messages according to the identifier information, the method further comprises:
if the forwarding modes of the target messages are the first forwarding mode, allocating a same forwarding identifier to the target messages; and
indicating the target messages to be forwarded from the forwarding domain corresponding to the forwarding identifier.

4. The method according to claim 2, wherein after determining the forwarding modes of the target messages according to the identifier information, the method further comprises:
if the forwarding modes of the target messages are the second forwarding mode, determining whether the target messages come from a same terminal;
if the target messages come from the same terminal, allocating the same forwarding identifier to the target messages;
if the target messages come from different terminals, allocating the same forwarding identifier to the target messages from the same terminal, and allocating different forwarding identifiers to the target messages from the different terminals; and
indicating the target messages to be forwarded from the forwarding domain corresponding to the forwarding identifier.

5. The method according to claim 4, determining whether the target messages come from the same terminal comprises:
parsing out an input port number in the identifier information carried in all target messages; and determining that the target messages with the same input port number in the identifier information come from the same terminal;
determining that the target messages with the different input port numbers in the identifier information come from the different terminals;

6. The method according to claim 1, before acquiring the target messages from the different input ports, the method further comprises:
allocating the input port numbers to the input ports, where the input port numbers allocated to different ports from the same terminal are the same, and the input port numbers allocated to the different input ports from the different terminals are different.

7. A forwarding domain allocation device, comprising:
a first acquiring module, configured to acquire target messages from different input ports, and a number of the acquired target messages being greater than or equal to a number of input ports;
a second acquiring module, configured to acquire identifier information carried in the target messages;
an allocating module, configured to allocate forwarding domains to the target messages according to the identifier information carried in the target messages.

8. The device according to claim 7, wherein the allocating module is further configured to determine forwarding modes of the target messages according to the identifier information carried in the target messages;
the forwarding mode comprises a first forwarding mode for indicating the target messages to be forwarded by a same forwarding domain, and a second forwarding mode for indicating the target messages to be forwarded by different forwarding domains.

9. A non-transitory computer-readable storage medium, wherein a computer program is stored in the storage medium, the computer program is configured to run to execute the method as claimed in claim 1.

10. An electronic device, comprising a memory and a processor, wherein a computer program is stored in the memory, and the processor is configured to execute the computer program to execute the method as claimed in claim 1.

11. The method according to claim 2, before acquiring the target messages from the different input ports, the method further comprises:
allocating the input port numbers to the input ports, where the input port numbers allocated to different ports from the same terminal are the same, and the input port numbers allocated to the different input ports from the different terminals are different.

12. The method according to claim 3, before acquiring the target messages from the different input ports, the method further comprises:
allocating the input port numbers to the input ports, where the input port numbers allocated to different ports from the same terminal are the same, and the input port numbers allocated to the different input ports from the different terminals are different.

13. The method according to claim 4, before acquiring the target messages from the different input ports, the method further comprises:
allocating the input port numbers to the input ports, where the input port numbers allocated to different ports from the same terminal are the same, and the input port numbers allocated to the different input ports from the different terminals are different.

14. The method according to claim 5, before acquiring the target messages from the different input ports, the method further comprises:
allocating the input port numbers to the input ports, where the input port numbers allocated to different ports from the same terminal are the same, and the input port numbers allocated to the different input ports from the different terminals are different.

15. An electronic device, comprising a memory and a processor, wherein a computer program is stored in the memory, and the processor is configured to execute the computer program to execute the method as claimed in claim 2.

16. An electronic device, comprising a memory and a processor, wherein a computer program is stored in the memory, and the processor is configured to execute the computer program to execute the method as claimed in claim 3.

17. An electronic device, comprising a memory and a processor, wherein a computer program is stored in the memory, and the processor is configured to execute the computer program to execute the method as claimed in claim 4.

18. An electronic device, comprising a memory and a processor, wherein a computer program is stored in the memory, and the processor is configured to execute the computer program to execute the method as claimed in claim 5.

19. An electronic device, comprising a memory and a processor, wherein a computer program is stored in the memory, and the processor is configured to execute the computer program to execute the method as claimed in claim 6.

20. A non-transitory computer-readable storage medium, wherein a computer program is stored in the storage medium, the computer program is configured to run to execute the method as claimed in claim 2.
